(19) United States
(12) Patent Application Publication
(10) Pub. No.: US 2024/0114052 A1
(43) Pub. Date: Apr. 4, 2024

(54) NETWORK SECURITY SYSTEM FOR PREVENTING SPOOFED IP ATTACKS

(71) Applicant: Provallo, Inc., San Francisco, CA (US)

(72) Inventors: Yaniv Karta, San Francisco, CA (US); Moshe M. Vered, Pijnacker (NL)

(21) Appl. No.: 17/957,720

(22) Filed: Sep. 30, 2022

Related U.S. Application Data
(60) Provisional application No. 63/253,421, filed on Oct. 7, 2021.

(51) Int. Cl. H04L 9/40; H04L 41/16

(52) U.S. Cl. CPC H04L 63/1466; H04L 41/16; H04L 63/0245; H04L 63/1425

(57) ABSTRACT

A network security system detects and prevents network attacks in real-time using machine learning. The network security system trains machine-learned models using past network attack data such that the models are configured to identify portions of data packets that correspond to particular types of attacks, such as spoofed IP attacks. In some embodiments, the machine-learned models are configured to identify malicious signal noise from portions of data packets and to identify a type of unknown attack corresponding to the malicious signal noise. The machine-learned models are applied to real-time data traffic to identify attacks. The network security system performs security operations when attacks are detected, such as using a virtual router interface to identify a source of a spoofed IP attack, thereby mitigating the effects of the attack.

### CROSS REFERENCE TO RELATED APPLICATIONS

This application claims the benefit of U.S. Provisional Application No. 63/253,421, filed Oct. 7, 2021, which is incorporated by reference in its entirety.

### TECHNICAL FIELD

The disclosure generally relates to the field of network security, and specifically to a network security system designed to prevent network attacks.

### BACKGROUND

Computer networks transmit data between devices. To prevent attacks from malicious actors, who can infiltrate and abuse resources of a network, an administrator may implement network infrastructure to detect and respond to security threats. Conventional network security systems require high processing power and significant network resources, resulting in time and cost inefficiencies for network users. Accordingly, there is a need to improve the efficiency of network security measures to detect and prevent network attacks.

### SUMMARY

A network security system uses machine learning to detect and prevent spoofed internet protocol (IP) attacks. The network security system generates a training data set with information representative of historical data packets transmitted during past spoofed IP attacks. A machine-learned model is trained with the training data set such that the model is configured to identify signal noise within one or more packet fields correlative to spoofed IP attacks and classify the identified signal noise as malicious or benign. The network security system applies a preprocessing classifier to real-time data packets transmitted to a network node, producing a filtered set of data packet information. The filtered set of data packet information includes field values corresponding to the one or more packet fields that are correlated with spoofed IP attacks. The network security system applies the trained machine-learned model to the filtered set of data packet information; the machine-learned model classifies signal noise within the filtered set of data packet information as malicious. The network security system subsequently instantiates a virtual router interface that queries additional network nodes to identify a source of the data packets transmitted to the network node. In response to identifying an IP address as the source of the data packets transmitted to the network node, the network security system performs a security operation based on the IP address. In some embodiments, a non-transitory computer readable storage medium performs the steps described above.

A network security system uses machine learning to prevent unknown network attacks. The network security system generates a training data set that includes information representative of historical data packets transmitted during past network attacks. The network security system trains a machine-learned model using the training data set such that the machine-learned model is configured to identify signal noise within one or more packet fields correlative to network attacks and to classify the identified signal noise as malicious or benign. The network security system applies a preprocessing classifier to real-time data packets transmitted to a network node, resulting in a filtered set of data packet information comprising field values corresponding to the one or more packet fields correlative to network attacks. The network security system applies the machine-learned model to the filtered set of data packet information, which classifies malicious signal noise within the filtered set of data packet information. The network security system checks whether the malicious signal noise corresponds to a known network attack. In response to determining that the malicious signal noise does not correspond to a known network attack, the network security system applies a postprocessing classifier to the signal noise within the filtered set of data packet information. The postprocessing classifier identifies a type of unknown attack associated with the malicious signal noise. The network security system performs a security operation based on the identified type of unknown attack. In some embodiments, a non-transitory computer readable storage medium performs the steps described above.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a network, in accordance with an example embodiment.

FIG. 2 is a high-level block diagram of a data packet, in accordance with an example embodiment.

FIG. 3 is a flow diagram illustrating training and applying machine learned models configured to identify malicious data signals, in accordance with an example embodiment.

FIG. 4 is a flow diagram illustrating simulation and virtual detonation of malicious data signals, in accordance with an example embodiment.

FIG. 5A illustrates an example process for preventing spoofed IP attacks, in accordance with an example embodiment.

FIG. 5B illustrates an example process for preventing unknown network attacks, in accordance with an example embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A letter after a reference numeral, such as “120A,” indicates that the text refers specifically to the element having that particular reference numeral. A reference numeral in the text without a following letter, such as “120,” refers to any or all of the elements in the figures bearing that reference numeral.

The figures depict embodiments of the disclosed system (or method) for purposes of illustration only. One skilled in the art will readily recognize from the following description that alternative embodiments of the structures and methods illustrated herein may be employed without departing from the principles described herein.

### Network Security System Overview

To protect the security of data transmitted through a network, a network security system detects and responds to attacks by malicious actors. Malicious actors may infiltrate the network to access private data, abuse network resources, and/or remotely execute malicious code on network devices. Conventional security methods often require the analysis of entire network data flows to detect an attack, consuming considerable processing power and network resources. Thus, the real-time detection of network attacks can be unreliable and expensive. As the sophistication, intensity, and types of attacks continue to evolve, there is a need to improve the efficiency with which network security systems identify and mitigate these data security threats.

The network security system described herein uses machine learning to detect network attacks. Instead of assessing all the data passing through the network (“data traffic”), the network security system samples a portion of the data traffic to check for malicious activity. The network security system trains and applies machine-learned models configured to check for malicious activity based on the sampled portions of the data traffic. In response to the machine-learned models identifying data traffic as malicious, the network security system executes security operations that mitigate the effects of the attack.

### System Environment

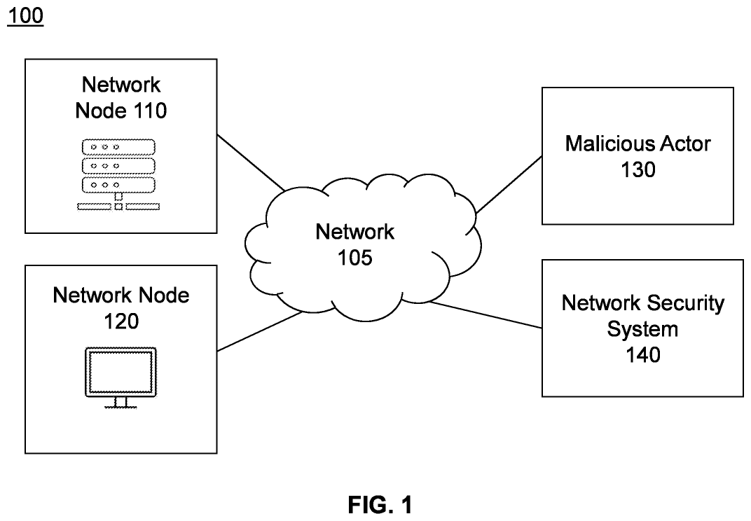

FIG. 1 is a high-level block diagram of a system environment for a network 105, in accordance with an example embodiment. In addition to the network 105, the system environment 100 includes network nodes 110 and 120, a malicious actor 130, and the network security system 140. In some embodiments, the system environment 100 includes components other than those described herein. For clarity, although FIG. 1 only shows two network nodes 110 and 120 and one malicious actor 130, alternate embodiments of the system environment 100 can have any number of network nodes and/or malicious actors. Additional components such as web servers, network interfaces, security functions, load balancers, failover servers, management and network operations consoles, and the like are not shown so as to not obscure the details of the system environment.

The network 105 transmits data within the system environment 100. The network 105 transmits data packets between a plurality of network nodes, including the network nodes 110 and 120. The network 105 may be a local area or wide area network using wireless or wired communication systems, such as the Internet. In some embodiments, the network 105 transmits data over a single connection (e.g., a data component of a cellular signal, or Wi-Fi, among others), or over multiple connections. The network 105 may include encryption capabilities to ensure the security of data transmitted through the system environment 100. For example, encryption technologies may include secure sockets layers (SSL), transport layer security (TLS), virtual private networks (VPNs), and Internet Protocol security (TPsec), among others.

Each network node 110 and 120 is a device connected to the network 105 that can receive, process, store, and send data. The network nodes 110 and 120 may send data to one another, and/or other nodes within the network 105. Each of the network nodes 110 and 120 may be, for example, a server, a client device, a router, a switch, a bus, a hub, a bridge, a gateway, a modem, a repeater, a printer, an access point, and/or a firewall. In some embodiments, the network nodes 110 and 120 are virtual devices.

The malicious actor 130 is an entity unauthorized to access the network 105. The malicious actor 130 may infiltrate the network 105 to access, capture, and/or corrupt data transmitted through the network 105. The malicious actor 130 may attack the network 105 by sending a malicious data signal through the network 105. Network attacks can include a spoofed internet protocol (IP) address attack (e.g., where an attacker submits an unauthorized bind request to access the network's IP address), reflective attack (e.g., where an attacker uses the network's IP address to attack a third party), a man in the middle attack (e.g., where an attacker intercepts an existing network session through a network node and captures data transmitted to and from the network node, potentially eavesdropping on communications occurring within the network), remote code execution (e.g., where an attacker remotely executes malware on a network node, thereby corrupting and/or comprising the security of the network node), a free rider attack (e.g., where an attacker with unauthorized access to the network abuses network resources), or some combination thereof. The malicious actor 130 may infiltrate and attack the network 105 in ways other than those described here.

The network security system 140 implements security measures to detect, prevent, and mitigate attacks on the network 105 by malicious actors (e.g., including the malicious actor 130). In some embodiments, the network security system 140 is a network node (e.g., one of the network nodes 110 or 120) and/or part of a network node within the network 105. For example, the network security system 140 may be a firewall, proxy server, or a gateway. In some embodiments, the network security system 140 is part of software that is installed on a network node. The network security system 140 trains machine-learned models using portions of data traffic sent through the network 105 during past network attacks. When applied to real-time data traffic, the machine-learned models identify malicious data signals and classify a type of network attack associated with the malicious data signals. After identifying the malicious data signals, the network security system 140 executes security operations to mitigate the malicious attack on the network 105. Examples of security operations include identifying an IP address of the malicious actor 130, notifying users of the network 105 of the attack, blocking incoming data traffic from the malicious actor 130, launching a sandbox (e.g., a temporary testing environment) to test mitigation of the malicious data signals, and so on.

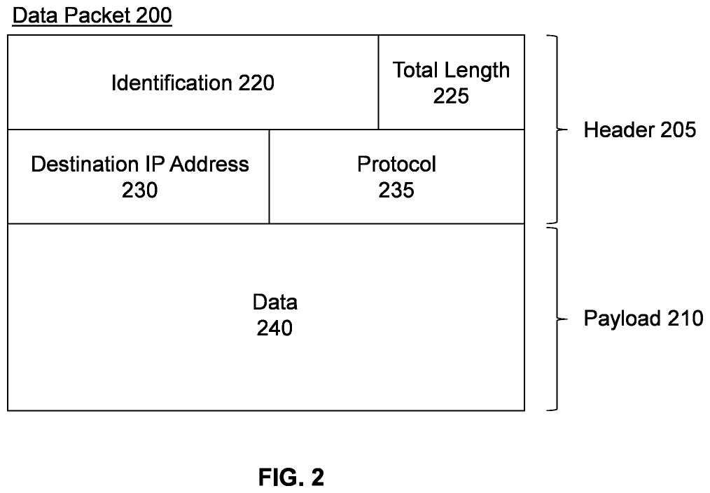

FIG. 2 is a high-level block diagram of a data packet 200, in accordance with an example embodiment. Data is transmitted between network nodes (e.g., the network nodes 110 and 120) through the network 105 in the form of multiple data packets, including the data packet 200. The data packet 200 includes a number of fields, separated into a header 205 and a payload 210. The header 205 comprises information about the data packet 200, including an identification number 220 and a total length 225 (e.g., in bits). The header 205 also comprises instructions for the data packet 200, including a destination IP address 230 and a packet transfer protocol 235. The packet transfer protocol 235 specifies the formatting of data so that a receiving network node can interpret the incoming data. Examples of packet transfer protocols are user datagram protocol (UDP) and transmission control protocol (TCP). The payload 210 stores data 240 transported by the data packet 200. The data packet 200 may include components other than those described herein; components may be distributed differently than those depicted herein. For example, the data packet 200 may include a source IP address (e.g., indicating a source of the data packet 200), a sequence number of the data packet 200 (e.g., the sequence in which several data packets, including the data packet 200, need to be assembled in), and so on.

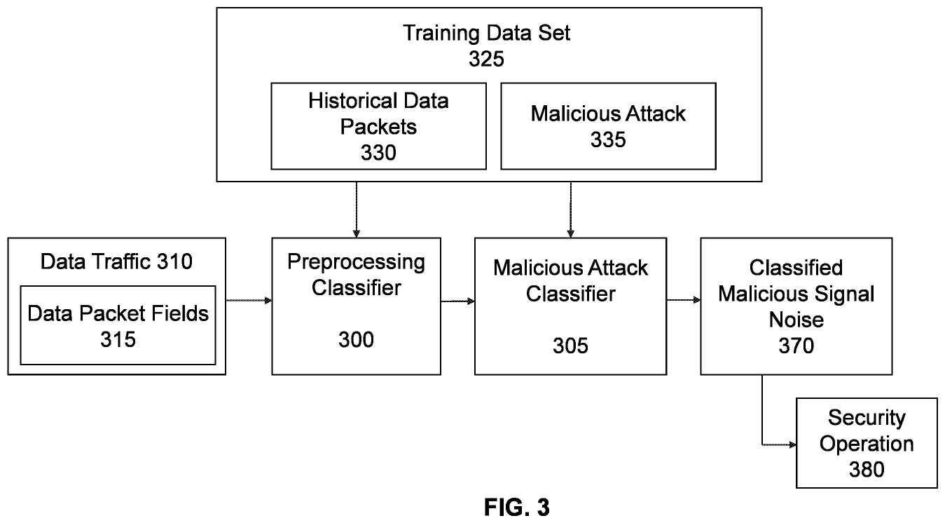

The network security system 140 detects malicious data signals, using machine learning, from portions of real-time data traffic transmitted through the network 105. In particular, the network security system 140 uses machine-learned models to determine whether a portion of a data packet's header 205 and/or payload 210 corresponds to malicious or benign signal noise. In addition, the machine-learned models can distinguish between types of malicious attacks, based on the signal noise. The training and application of the machine-learned models is further discussed with respect to FIG. 3.

### Machine-Learned Models Configured to Identify Malicious Data Signals

FIG. 3 is a flow diagram illustrating training and applying machine learned models configured to identify malicious data signals, in accordance with an example embodiment. The network security system 140 trains and applies a preprocessing classifier 300 and a malicious attack classifier 305 to identify malicious data signals.

The preprocessing classifier 300 identifies portions of data traffic 310, traveling in real-time through the network 105, that correspond to malicious network attacks. In some embodiments, the portions of the data traffic 310 are sampled based on local network statistics and/or attributes of the local network 105. For example, the network security system 140 may sample portions of the data traffic 310 based on operating systems, computing platforms, deployment architecture, network interfaces, network protocols, and route configuration of the network 105. In another example, the network security system 140 may account for attributes relating to internet control message protocol (ICMP) hosts and/or ports, steam control transmission protocol (SCUP) associations, IP/UDP/TCP checksum counters, and so on.

In other embodiments, the network security system 140 samples portions of the data traffic 310 based on real-time network data captured by network nodes (e.g., a networking interface, a router, gateway, or a host computing device). The network nodes may capture the data using, for example, virtual network interfaces, transport driver interface (TDI) kernel filters, Windows sockets service providers, user-mode net filter net queues, extended Berkeley Packet Filters, kernel mode net filter hooks, network tunnels and/or tap devices, packet capture frameworks, policy and charging rules functions (PCRF), and so on. The network security system 140 may account for network attributes in sampling portions of the data traffic 310, such as IP protocol options, IP family, data packet length, flags, address families, transport protocol types and options, data packet payload features, application payload size and type, network interface index, IP protocol resets, input/output specifiers, type of service and/or time to live for each data packet, and so on. Real-time network data samples may be pre-processed to produce a portion of the data traffic 310 that is time series and/or spectral ordered. In some embodiments, the pre-processing may produce first, second, or partial derivatives, and/or real, discrete, or sparse features. This pre-processing of real-time network data helps the network security system 140 classify malicious data signals into specific types of malicious attacks.

The malicious attack classifier 305 determines a type of the corresponding malicious network attack. The network security system 140 trains the preprocessing classifier 300 and the malicious attack classifier 305 using a training data set 325. The training data set 325 includes historical data packets 330, which are data packets (e.g., similar to the data packet 200) that were transmitted during past malicious network attacks. Each of the historical data packets 330 includes data packet fields, including a header and a payload (e.g., similar to the header 205 and the payload 210 of the data packet 200). Additionally, each historical data packet 330 is associated with a corresponding type of malicious attack 335. In some embodiments, the corresponding type of malicious attack 335 is labeled (e.g., by an administrator of the network 105). Examples of malicious attacks 335, as described with respect to FIG. 1, include spoofed IP address attacks, man in the middle attacks, remote code execution attacks, free rider attacks, and so on.

The training data set 325 may also include characteristics about data traffic during past malicious attacks, such as geographic origins, data transmission rates, and/or network protocols associated with each historical data packet 330. Additionally, the training data set 325 may include information about network nodes that transmitted, received, and/or exchanged each historical data packet 330, such as network interface controller information (e.g., speed of data transmission, IP address and media access control (MAC) address, manufacturer, etc.) and other local host variables. In some embodiments, the training data set 325 includes an incident summary for each past malicious attack, including an origin of the identified attacker, the target of the attack, network name, total amount of traffic attempted to flow to the target, total computational cost of the attack, memory affected by the attack, and so on. In some embodiments, the training data sets vary for each of the two machine-learned models.

The training data set 325 may be separated into a positive training set and a negative training set. The positive training set includes data packet fields (e.g., portions of headers and/or payloads) of the historical data packets 330, information about data traffic, and/or information about network nodes associated with specific types of malicious attacks 335. The negative training set includes portions of historical data packets 330 that are associated with benign (e.g., non-malicious) network activity.

The network security system 140 uses the positive and negative training sets to train the preprocessing classifier 300 and the malicious attack classifier 305. During training, the machine-learned models 300 and 305 learn to identify relationships between data packet fields, data traffic characteristics, and network node information and specific types of malicious network attacks. Specifically, the preprocessing classifier 300 learns to identify particular data packet fields as malicious signal noise. The malicious attack classifier 305 correlates the malicious data signal noise with specific types of malicious network attacks.

The network security system 140 uses unsupervised learning, or, in other embodiments, supervised learning, to train the machine learned models 300 and 305. Different machine learning techniques may be used in various embodiments, such as linear support vector machines (linear SVM), boosting for other algorithms (e.g., AdaBoost), neural networks, logistic regression, naïve Bayes, memory based learning, random forests, bagged trees, decision trees, boosted trees, boosted stumps, and so on.

After training of the models 300 and 305, the network security system 140 applies the preprocessing classifier 300 to the real-time data traffic 310 transmitted to a network node (e.g., the network node 110). The preprocessing classifier 300 analyzes real-time data packet fields 315 to identify the real-time data traffic 310 as malicious or benign. As output, the preprocessing classifier 300 produces a filtered set of data packet fields 315 that corresponds to malicious network attacks (“malicious signal noise”). For example, the preprocessing classifier 300 may determine that data packets with a particular total length and protocol (e.g., similar to the total length 225 and the protocol 235 of the data packet 200) are correlated with malicious activity. In some embodiments, the preprocessing classifier 300 accounts for data traffic characteristics and/or information from network nodes to filter out the data packet fields 315 correlated with malicious activity. Malicious activity may be detected from, for example, data packet fields that do not comport with the specified protocol, requests to map and return IP addresses of the network 105 and network nodes, and data payloads that are incompatible with various network nodes.

The network security system 140 applies the malicious attack classifier 305 to the filtered set of data packets 315. As output, the malicious attack classifier 305 classifies the malicious signal noise 370, identifying a malicious attack on the network 105 in real-time. In some embodiments, the malicious attack classifier 305 may determine that the malicious attack is of an unknown or new type. The network security system 140, in such cases, applies a postprocessing classifier to the classified malicious signal noise 370 to identify the unknown attack. The postprocessing classifier may be a component of the malicious attack classifier 305. In some embodiments, the postprocessing classifier is separate from the malicious attack classifier 305 and relies on data traffic characteristics to identify the type of malicious attack.

In some embodiments, the machine-learned models 300 and 305 can predict attacks prior to receiving malicious signal noise 370 based on local network statistics, information about network nodes, and so on.

The machine-learned models 300 and 305, as well as the postprocessing classifier, can be retrained based on the classified malicious signal noise 370. The network security system 140 may add the set of filtered data packet fields 315 and/or the identified type of malicious attack to the training data set 325 for subsequent retraining of the models. In some embodiments, users and/or administrators of the network 105 may provide feedback to the network security system 140 on the accuracy of the machine-learned models; the network security system 140 may add this feedback to the training data set 325 for subsequent training of the models as well.

The network security system 140 performs various actions after identifying a malicious attack in real-time. The network security system 140 may identify a risk associated with the identified malicious attack and act accordingly. For example, the network security system 140 may calculate the potential cost of the malicious attack and inform network administrators of the monetary risk. In another example, when the network security system 140 after classifying malicious signal noise 370 as correlative with a spoofed IP attack, the network security system 140 may instantiate a virtual router interface to identify a source of the malicious attack (e.g., the malicious actor 130). The virtual router interface identifies a source IP address for the malicious real-time data traffic 310 after a threshold number of network nodes (e.g., including the network nodes 110 and 120) all identify the same source IP address for the malicious real-time data traffic 310. The threshold may be set by an administrator of the network 105, and/or designated by the network security system 140 itself. In some embodiments, the malicious real-time data traffic 310 includes identifying information that indicates the source of the malicious attack. For example, the headers and/or payloads of the filtered data packet fields 315 corresponding to the malicious signal noise 370 may include such identifying information.

The network security system 140 may also perform security operations 380 after classifying the malicious attack. For example, the network security system 140 may block new incoming data traffic from the identified source of the malicious attack (e.g., from the source IP address or a subnet associated with the source). The network security system 140 blocks and drops new incoming malicious data traffic for reflective attacks and scans, which may potentially impair network performance, as well as remote code execution attacks, which affects the performance of network nodes hosting the malicious data traffic (e.g., host performance). The network security system 140 may block and drop malicious data traffic transmitted by particular network nodes and/or based on properties of the malicious data packets. For example, the network security system 140 may block and drop incoming data packets from a classless interdomain routing (CIDR) IPv6 and/or IPv4 subnet. In another example, the network security system 140 may block malicious data packets with a particular autonomous system number (ASN), IP address, and/or those originating from a particular geographic location.

In another example, the network security system 140 may notify other network nodes in the network 105 of the source and/or type of the malicious attack, notify network administrators of the network 105 of the source and/or type of the malicious attack, eliminate the current network session, update security programs and software, require more robust user authentication, and so on.

The network security system 140 may launch a sandbox (e.g., a temporary testing environment) to test how the incoming malicious data traffic would impact the network 105. The sandbox may also be used to test the efficacy of network security tools against the identified malicious attack. The network security system 140 launches sandboxes for free rider attacks and man in the middle attacks, which pose server and user privacy risks to the network, respectively.

In some embodiments, the security operations 380 are specified by a user and/or administrator of the network 105. The network security system 140 may generate and implement new security operations 380 as new and/or unknown attacks are identified. In some embodiments, users of the network 105 set expiration dates for certain security operations 380, edit and/or update security operations 380, and/or schedule security operations 380 in advance. In other embodiments, the network security system 140 automatically applies and/or revokes security operations 380 based on the identified type of malicious attack.

The network security system 140 may take actions to mitigate the effects of a malicious attack. The network security system 140 may, for example, predict channel failure, network node overload, resource exhaustion, operating system strain, memory exhaustion, and/or session constraints due to a malicious attack. After detecting a malicious attack, and prior to any of the above failures, the network security system 140 may take actions to prevent harmful effects of the malicious attack. The network security system 140 may use the machine-learned models 300 and 305, trained on network statistics and information about network nodes, to identify the potential risk and effects of malicious attacks.

Network channels may fail (e.g., where data packets cannot be transmitted between network nodes) due to a malicious attack. In response, the network security system 140 may reroute all session traffic to a different network node. In some embodiments, the network security system 140 blocks the creation of new channels if there is a risk of channel failure.

Network node overload occurs when malicious traffic exhausts the operating system kernel resources and affects existing sessions, as well as the stability of one or more network nodes. In response, the network security system 140 may “evict” an existing session by redirecting the data traffic 310 to different network nodes.

When the network security system 140 predicts resource exhaustion, which can impact stability of the network 105 and its network nodes, the network security system 140 creates and load balances physical and virtual resources, such as network adapters, during peak traffic windows. The physical and virtual load balancers are destroyed when the traffic flow reduces.

The network security system 140 can also predict when operating system resources (e.g., memory, scheduling prioritization processes, and so on) are strained and/or overused, and in response, reset operating system attributes (e.g., the number of open file descriptors, number of sockets, send and/or receive buffers). In some embodiments, after predicting constrained operating system resources, the network security system 140 redirects new sessions and/or evicts existing sessions.

Additionally, when the network security system 140 predicts memory exhaustion, where an attacker may leak, capture, and/or delete what is stored within the network 105, the network security system 140 may migrate existing sessions to other network nodes without interrupting the sessions. Finally, the network security system 140 may predict session constraints, where the quality of a channel, its buffer size, or bandwidth may be affected. In response, the network security system 140 may redirect session participants.

### Simulation and Virtual Detonation of Malicious Data Signals

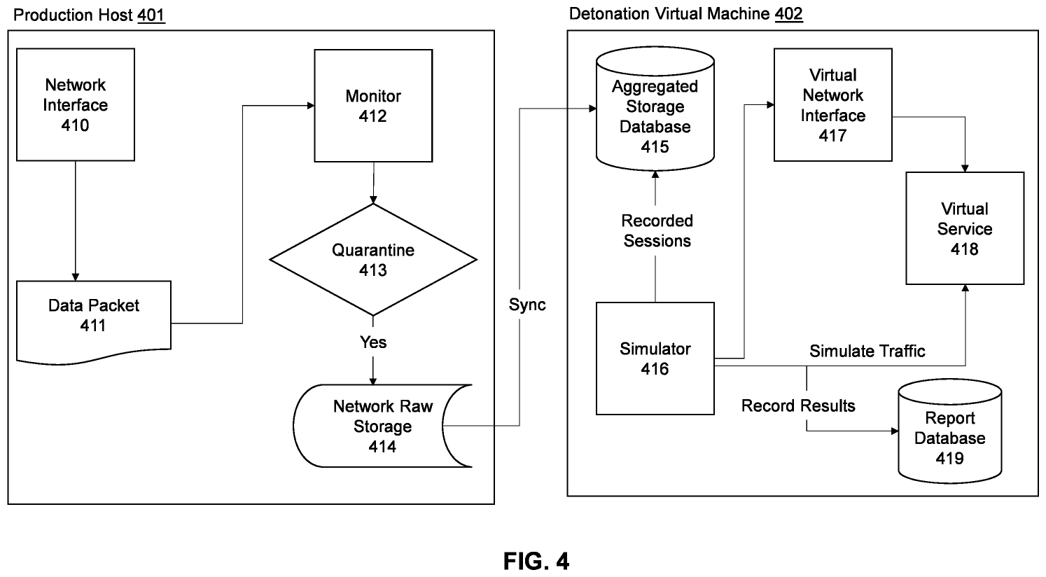

FIG. 4 is a flow diagram illustrating simulation and virtual detonation of malicious data signals, in accordance with an example embodiment. The network security system 140 may simulate the routing of the malicious data traffic 310 through the network 105 and subsequently detonate the malicious data traffic 310. FIG. 4 depicts a production host 401, where network sessions occur and may be recorded, and a detonation virtual machine 402, where the malicious data traffic is simulated and subsequently detonated. The production host 401, the detonation virtual machine 402, and/or each of their components may be network nodes (or part of one or more network nodes) in the network 105).

The production host 401 receives incoming data traffic 310 through a network interface 410. The data includes the data packet 411, which the production host 401 forwards to a monitor 412. The monitor 412 uses machine learning, as described with respect to FIG. 3, to detect that the data packet 411 is malicious (e.g., the malicious signal noise 370). The monitor 412 also determines the relevant security operations 380 to apply to the malicious data packet 411. For example, the monitor 412 may determine that the malicious data packet 411 must be quarantined 413; the malicious data packet 411 is then stored in a network raw storage 414.

The detonation virtual machine 402 simulates and virtually detonates malicious signal noise associated with the malicious data packet 411. The production host 401 records network sessions (e.g., of data traffic 310 including the malicious data packet 411). The recorded network sessions, as well as relevant information about the network sessions collected from network nodes, is stored in an aggregated storage database 415. The additional information collected from the network nodes may include, for example, a session duration and/or host for each recorded network session.

A simulator 416 uses the recorded network sessions, as well as relevant information about the network sessions, to replay the network sessions as well as to simulate stability performance and/or risk issues recorded on the production host 401. To simulate the network session, the simulator 416 queries the recorded network sessions, including metadata associated with the data traffic 310 and the stored network session information. In some embodiments, the simulator 416 further applies filters (e.g., relating to a specific attribute or offset value) to simulate a particular network session. The simulator 416 may generate data across various network device interfaces with data attributes and payload information corresponding to the original data traffic 310. In some embodiments, the simulator 416 employs a “fuzzing” mode, where the simulator generates and permutes data attributes related to protocol stack offsets and values associated with a risk category. The simulator 416 then analyzes the behavior of the simulated malicious data traffic. For example, the simulator 416 may change values of a dangerous payload to fit current service and/or interface configurations, route, fragmentation, and/or other variables that may affect the simulation of the malicious data traffic. In other embodiments, the simulator 416 employs an “infer” mode, where the simulator dispatches network sessions for the purpose of automatic labeling of similar performance or security behavioral patterns and rebalances the datasets to reflect any newly labeled performance or risk categories.

A virtual network interface 417 may be used to simulate advanced routing issues, routing simulated data packets to a virtual service 418. The virtual service 418 simulates running protocol services on the production host 401, such as domain name system (DNS), interactive connectivity establishment (ICE), simple traversal of User Datagram Protocol (STUN), traversal using relays around NAT (TURN), session initiation protocol (SIP), and so on. The virtual service 418 deployment configuration may be in a containerized environment, on a virtual machine, directly running on a hardened host, or some combination thereof. The virtual service 418 also records host stability counters, such as CPU, session flow, handling of various protocols, memory, networking stack status for service processes, the host operating system during the simulation, crash logs, and crash information during the simulation. In some embodiments, the simulation may be evaluated against service crashes or successful remote code execution (e.g., comparing predicted instruction pointer, value controlled register value criteria, and so on). The results of each of these stability metrics are stored in a report database 419 and can be used to improve the performance of network security features and/or determination of risk associated with various malicious network attacks.

### Process for Preventing Spoofed IP Attacks

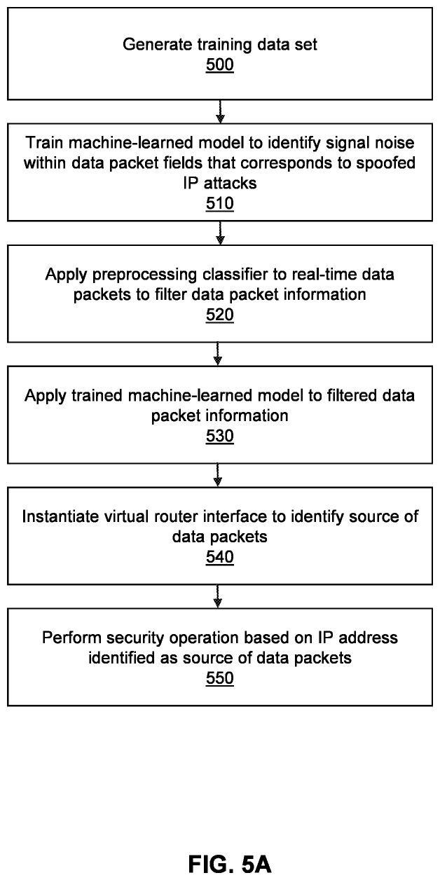

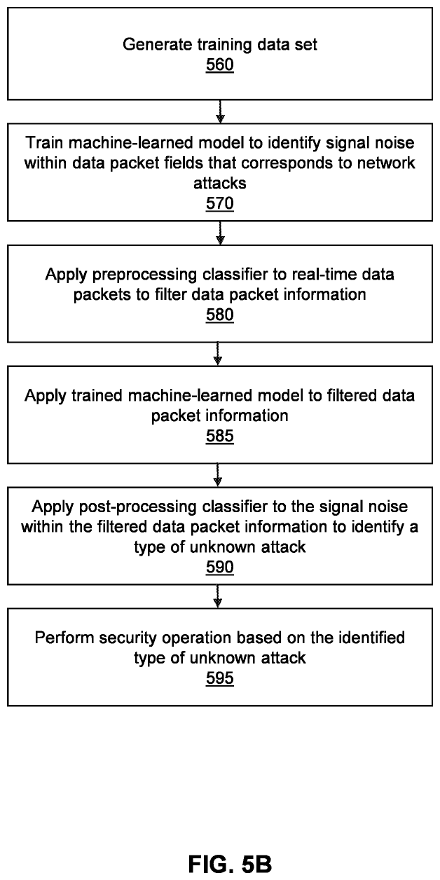

FIG. 5A illustrates an example process for preventing spoofed IP attacks, in accordance with an example embodiment. A network security system (e.g., the network security system 150) generates 500 a training data set (e.g., the training data set 325) comprising historical data packets transmitted during past spoofed IP attacks.

The network security system trains 510 a machine-learned model (e.g., the malicious attack classifier 305) using the training data set. The machine-learned model is configured to identify signal noise within one or more data packet fields (e.g., the data packet fields 315) that correspond to spoofed IP attacks. The machine-learned model is also configured to classify the identified signal noise as malicious or benign.

The network security system applies 520 a preprocessing classifier (e.g., the preprocessing classifier 300) to real-time data packets (e.g., the data traffic 310) transmitted to a network node in a network (e.g., the network node 110 in the network 105). The preprocessing classifier filters information about the real-time data packets to generate a set of data packet information that corresponds to a malicious signal; the filtered set of data packet information includes data packet fields correlative to spoofed IP attacks. The network security system applies 530 the machine-learned model to the filtered set of data packet information.

The network security system instantiates 540 a virtual router interface to query network nodes in the network for a source of the malicious data traffic transmitted to the network node. After a threshold number of network nodes all identify the same IP address as the source of the malicious data traffic, the network security system performs 550 a security operation based on the IP address.

### Process for Preventing Unknown Attacks

FIG. 4B illustrates an example process for preventing unknown network attacks, in accordance with an example embodiment. The network security system generates 560 a training data set comprising historical data packets transmitted during historical network attacks.

Using the training data set, the network security system trains 570 a machine-learned model to identify signal noise within one or more data packet fields that correspond to network attacks. The machine-learned model is also configured to classify the identified signal noise as malicious or benign.

The network security system applies 580 a preprocessing classifier to real-time data packets transmitted to a network node in a network. The preprocessing classifier filters information about the real-time data packets to generate a set of data packet information that corresponds to a malicious signal; the filtered set of data packet information includes data packet fields correlative to network attacks. The network security system applies 585 the machine-learned model to the filtered set of data packet information.

The network security system determines 590 that the malicious signal does not correspond to a known network attack and applies a postprocessing classifier to the filtered set of data packet information. As output, the postprocessing classifier identifies a type of the unknown attack associated with the malicious signal.

The network security system performs 595 a security operation based on the identified type of unknown attack.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for preventing spoofed internet protocol (IP) attacks comprising:
generating a training data set comprising information representative of historical data packets transmitted during historical spoofed IP attacks;
training a machine-learned model using the training data set, the machine-learned model configured to identify signal noise within one or more packet fields correlative to spoofed IP attacks and to classify the identified signal noise as malicious or benign;
applying a preprocessing classifier to real-time data packets transmitted to a network node to produce a filtered set of data packet information comprising field values corresponding to the one or more packet fields correlative to spoofed IP attacks;
applying the machine-learned model to the filtered set of data packet information;
in response to the machine-learned model classifying signal noise within the filtered set of data packet information as malicious, instantiating a virtual router interface configured to query one or more additional network nodes for a source of the data packets transmitted to the network node; and
in response to a threshold number of network nodes identifying a same IP address as the source of the data packets transmitted to the network node, performing a security operation based on the IP address.

2. The method of claim 1, wherein the security operation comprises at least one of:
blocking incoming data packets sent from the IP address; and
launching a temporary testing environment for incoming data packets sent from the IP address.

3. The method of claim 1, wherein the machine-learned model is further configured to classify the identified signal noise as malicious or benign based on information about the network node.

4. The method of claim 3, wherein the information about the network node comprises information about a network interface controller of the network node.

5. The method of claim 1, wherein the one or more packet fields correlative to spoofed IP attacks comprises at least one of a payload or a header of a data packet.

6. The method of claim 1, wherein the one or more packet fields correlative to spoofed IP attacks comprises a request to map and return an IP address of the network node.

7. The method of claim 1, wherein the network node is at least one of a server, a client device, a router, a switch, a bus, a hub, a bridge, a gateway, a modem, a repeater, an access point, a firewall, and a security system.

8. The method of claim 1, wherein responsive to classifying the signal noise as malicious, the machine-learned model is further configured to classify a type of a spoofed IP attack.

9. A non-transitory computer-readable storage medium storing executable instructions that, when executed by a hardware processor, cause the hardware processor to perform steps comprising:
generating a training data set comprising information representative of historical data packets transmitted during historical spooked IP attacks;
training a machine-learned model using the training data set, the machine-learned model configured to identify signal noise within one or more packet fields correlative to spoofed IP attacks and to classify the identified signal noise as malicious or benign;
applying a preprocessing classifier to real-time data packets transmitted to a network node to produce a filtered set of data packet information comprising field values corresponding to the one or more packet fields correlative to spoofed IP attacks;
applying the machine-learned model to the filtered set of data packet information;
in response to the machine-learned model classifying signal noise within the filtered set of data packet information as malicious, instantiating a virtual router interface configured to query one or more additional network nodes for a source of the data packets transmitted to the network node; and
in response to a threshold number of network nodes identifying a same IP address as the source of the data packets transmitted to the network node, performing a security operation based on the IP address.

10. The non-transitory computer-readable storage medium of claim 9, wherein the security operation comprises at least one of:
blocking incoming data packets sent from the IP address; and
launching a temporary testing environment for incoming data packets sent from the IP address.

11. The non-transitory computer-readable storage medium of claim 9, wherein the machine-learned model is further configured to classify the identified signal noise as malicious or benign based on information about the network node.

12. The non-transitory computer-readable storage medium of claim 11, wherein the information about the network node comprises information about a network interface controller of the network node.

13. The non-transitory computer-readable storage medium of claim 9, wherein the one or more packet fields correlative to spoofed IP attacks comprises at least one of a payload or a header of a data packet.

14. The non-transitory computer-readable storage medium of claim 9, wherein the one or more packet fields correlative to spoofed IP attacks comprises a request to map and return an IP address of the network node.

15. The non-transitory computer-readable storage medium of claim 9, wherein the network node is at least one of a server, a client device, a router, a switch, a bus, a hub, a bridge, a gateway, a modem, a repeater, an access point, a firewall, and a security system.

16. The non-transitory computer-readable storage medium of claim 9, wherein responsive to classifying the signal noise as malicious, the machine-learned model is further configured to classify a type of a spoofed IP attack.

17. A network security system comprising:
a hardware processor;
a non-transitory computer-readable storage medium storing executable instructions that, when executed, cause the hardware processor to perform steps comprising:
generating a training data set comprising information representative of historical data packets transmitted during historical spooked IP attacks;
training a machine-learned model using the training data set, the machine-learned model configured to identify signal noise within one or more packet fields correlative to spoofed IP attacks and to classify the identified signal noise as malicious or benign;
applying a preprocessing classifier to real-time data packets transmitted to a network node to produce a filtered set of data packet information comprising field values corresponding to the one or more packet fields correlative to spoofed IP attacks;
applying the machine-learned model to the filtered set of data packet information;
in response to the machine-learned model classifying signal noise within the filtered set of data packet information as malicious, instantiating a virtual router interface configured to query one or more additional network nodes for a source of the data packets transmitted to the network node; and
in response to a threshold number of network nodes identifying a same IP address as the source of the data packets transmitted to the network node,
performing a security operation based on the IP address.

18. The network security system of claim 17, wherein the security operation comprises at least one of:
blocking incoming data packets sent from the IP address; and
launching a temporary testing environment for incoming data packets sent from the IP address.

19. The network security system of claim 17, wherein the machine-learned model is further configured to classify the identified signal noise as malicious or benign based on information about the network node.

20. The network security system of claim 17, wherein the information about the network node comprises information about a network interface controller of the network node.
